(19) United States
(12) Patent Application Publication
(10) Pub. No.: US 2006/0151100 A1
(43) Pub. Date: Jul. 13, 2006

(54) Method and apparatus for manufacturing composite sheet-like materials

(76) Inventors: William D. Young III, Jackson, MS (US); David W. White, Nashville, TN (US)

Correspondence Address: DARBY & DARBY P.C., P. O. BOX 5257, NEW YORK, NY, 10150-5257, US

(21) Appl. No.: 10/258,838

(22) PCT Filed: Apr. 27, 2001
(86) PCT No.: PCT/US01/13615

§ 371 Date: Jul. 21, 2005

Related U.S. Application Data
(60) Provisional application No. 60/200,558, filed on Apr. 28, 2000.

(51) Int. Cl. B32B 37/24

(52) U.S. Cl. 156/276; 156/324

(57) ABSTRACT

A method of producing a composite laminate comprises the steps of feeding ground reclaimed material, for example carpet backing, to a dispersing station (16), dispersing the reclaimed material on a moving web (10), bringing an intermediate web (20) into engagement with the layer of reclaimed material, melting the reclaimed material to fuse the reclaimed material to the intermediate web, passing the laminate through compression rollers (28, 30) to control the thickness of the laminate, and cooling the laminate. The moving web (10) may comprise carpeting material in which case the melted reclaimed material is fused to the carpeting material (10) and intermediate web (20).

This invention relates to a method and apparatus for manufacturing composite layered sheets or tiles from reclaimed waste carpet materials and the like.

Historically, extrusion processes have been used to produce multilayered composite sheets from reground materials, fiber waste, and/or virgin materials. An extrusion process requires that a high quality consistent material be fed into the extruder to obtain a quality sheet product. Extrusion processes are sensitive to variations in material, bulk density, flow times and melt indices. These variations affect the material flow which can either starve or flood the screw resulting in variations in the extruded sheet in width, thickness, line speed, tensile strength, and surface tension, among other things.

The present invention provides a method for manufacturing composite layered sheets or tiles from reclaimed materials which is less sensitive to the quality and consistency of the input material than an extrusion process.

### SUMMARY OF THE INVENTION

Briefly, in accordance with the invention, a method of producing a composite laminate comprises the steps of feeding ground reclaimed material to a dispersing station, dispersing the reclaimed material on a moving web, bringing an intermediate web into engagement with the layer of reclaimed material, melting the reclaimed material to fuse the reclaimed material to the intermediate web, passing the laminate through compression rollers to control the thickness of the laminate, and cooling the laminate.

### BRIEF DESCRIPTION OF THE DRAWINGS

FIG. 1 is a partially schematic illustration of an apparatus and process for producing composite layered sheets and/or tiles from reclaimed waste carpet materials in accordance with a preferred embodiment of the invention; and

FIG. 2 is a sectional view of a composite layer sheet produced in accordance with the invention.

### DETAILED DESCRIPTION

U.S. Pat. No. 6,029,916 of White discloses a method and apparatus for reclaiming backing and fiber materials from waste carpet or the like. U.S. Pat. No. 6,029,916 is hereby incorporated by reference into this specification.

The apparatus and process disclosed in the '916 patent produce granulated reclaimed backing material together with fiber waste products. The present invention uses the reclaimed backing material to produce various different types of sheets, including single layer sheets and composite layered sheets or tiles which can be used in the carpet, auto and/or construction industries as well as others.

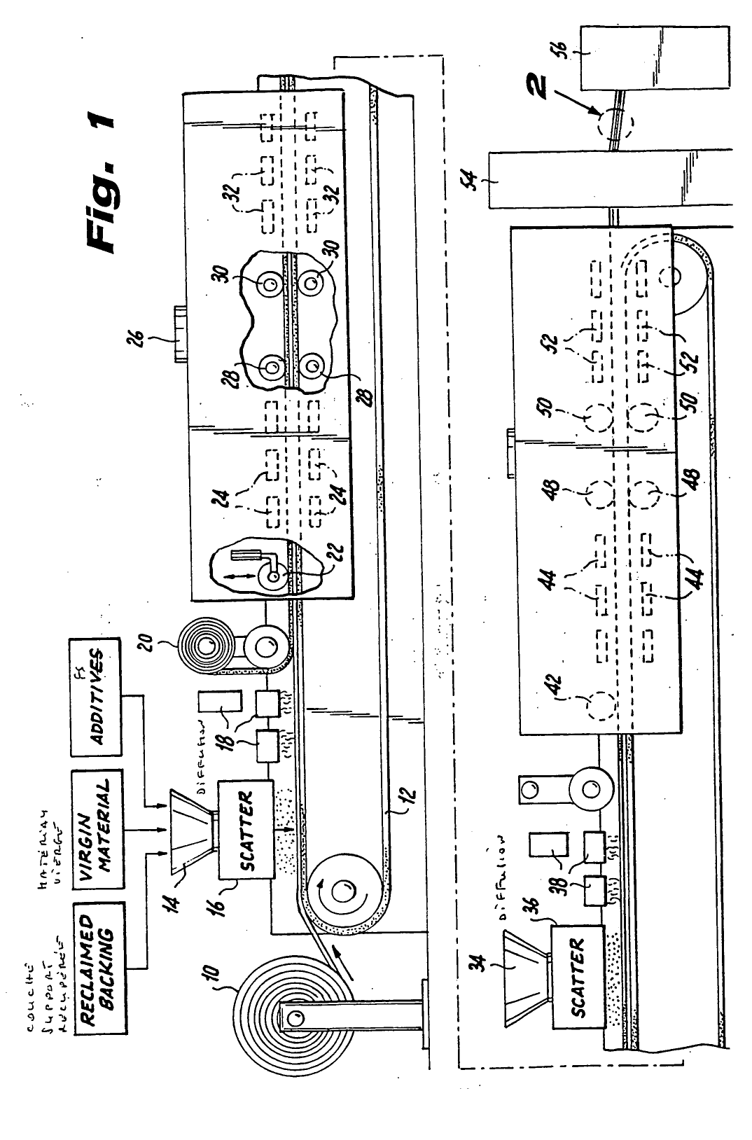

The process is described with reference to FIG. 1 which is a partially schematic illustration of an apparatus for producing a multi-layered composite material. For purposes of this description, the invention is described in connection with the production of a four-layer composite carpet tile.

Referring to FIG. 1, a roll of carpet fiber material is shown at 10. Any other material can be used. This material may form the visible or upper surface of the carpet and is provided without a backing.

The carpet fiber material is fed as a web to an endless conveyor belt 12 which conveys the carpet fiber web through the various operating stations of the apparatus. The carpet feed station may be a simple carpet unwind station (e.g. form Menzel Corporation) or it may consist of a sew-in station, accumulator and/or a J-box/scray to allow time to splice rolls of fabric, carpet, etc. together to allow uninterrupted flow. The first station comprises a mixer or blender 14 which combines the reclaimed materials (e.g. from hopper 294 of the '916 patent) with virgin material (if necessary) and other additives (such as coloring agents) according to a specified “recipe”. The reclaimed backing material and other input materials may be fed to the mixer by a conventional material handling system such as a Flexicon auger system, conveyor belt, or vacuum (e.g. the vacuum system from Process Control Corp).

The blended material within the mixer 14 is dispersed by gravity onto a displacement roller at a scattering station 16. A suitable mixer and scattering unit is sold by Schott & Meissner Co. The scattering station 16 places the granulated material from mixer 14 onto the fiber web 10 as it moves with the conveyor belt 12. The scattering rate is a function of the final product specifications and depends on the desired thickness of the product and the line speed. The materials can be preblended off line and/or a volumetric or gravimetric blender can be added to feed the scattering unit if needed.

In one practical embodiment, a tufted carpet fiber may be conveyed past station 16 at a belt speed of about 1.5 meters per minute. For a reclaimed carpet tile, scattering may be at a rate of about 0.5% per minute. The percent of volume is based on the quantity measuring means of a Schott and Meissner (1 meter) scattering unit. If a single layer sheet, for example 1.1 mm thick, is to be produced, the material from station 16 can be scattered directly onto the belt 12 at a rate of 0.6% per minute.

The web is then passed through an infrared heating station 18 which preheats the reclaimed material prior to the melting and fusing stage described below. In the example described above, an infrared heater from Glenro, Inc. set to a temperature of 100-110° C. was used.

In the illustrated embodiment, a laminate feed station is provided. In this station, an intermediate sheet such as a fiberglass sheet 20 can be introduced to the laminate. Any other intermediate sheet such as a prelaminated sheet or a woven reinforced sheet may also be used. Typically, the intermediate sheet functions as a reinforcement to enhance the strength of the final product. Its incorporation at this stage of the process avoids the need to use separate machines for each step in the production of a composite sheet. The laminate feed station includes suitable control rollers which bring the intermediate (fiberglass) sheet 20 into engagement with the preheated layer of reclaimed backing material on the fiber web 10.

From the laminate feed station, the three layer laminate is introduced to an oven which includes a calibration roller 22 which is preset for each product specification. The roller gap depends on the heat, time of contact and pressure and ensures an even distribution of the reclaimed material over the desired width of the web. For carpet tile, the precalibration roller may be compressed to a gap of 4.0 mm up to 8 mm specific to the thickness or sculpture in the top layer 10. For the single layer sheet, the setting may be 1.3 mm. The oven may comprise a Thermofix contact heat oven from Schott & Meissner or a Glenro laminating oven. An endless belt (not shown) keeps the material level and even as it moves through the oven.

After the precalibration, the material enters the heating section of the oven where heat is applied through heat plates 24 positioned as shown above and below the conveyor belt 12. The ability to apply heat from the top independently of the heat applied by the bottom plates through the conveyor belt allows multiple formulas for multiple product configurations. The number of heaters used depends on the final product specification. For carpet tile, the top heating units may be at 220° C. and the bottom heating units at 0° C. Three units are used for a one meter wide laminate. For the single layer sheet, both top and bottom heaters may be set at 220° C.

During this heating stage, which melts and fuses the reclaimed material to the fiber web 10 and the intermediate (fiberglass) sheet 20, the gasses and smoke produced are exhausted through a vent 26 and ducted to an acceptable point of discharge.

After the laminate has been fused it is passed through two pairs of calibrated compression or nip rollers 28 and 30 which are used to complete the desired thickness setting while the material is still soft. The setting on the calibration rollers 28, 30 corresponds to that of the precalibration roller 22. If desired, the upper roller(s) can be engraved in order to emboss the product to meet the specification of a particular customer.

After final compression by the nip rollers 28,30, the laminate flows through a group of parallel cooling plates 32. The cooling plates are cooled by an exterior chilling system for exact temperature control and can be controlled independently to permit flexibility for a wide range of product specifications. A cooling range between 10 and 15° C. may be used.

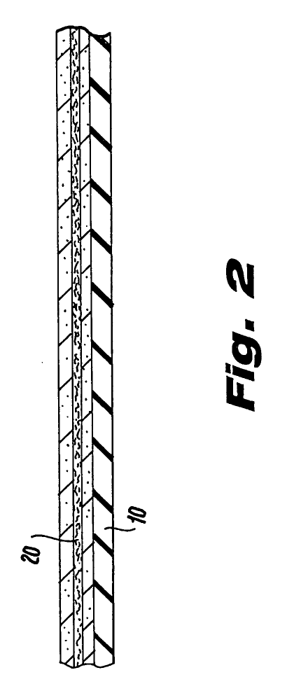

In the illustrated embodiment, the three layer composite is then fed through a second laminating process which is the same as the process described above. Thus, another layer of reclaimed material can be introduced to the three layer laminate by means of a second mixer 34 and scattering station 36. In this case, the reclaimed material is deposited on top of the intermediate (fiberglass) web 20. It is then preheated by infrared heaters 38 and, if desired, aligned with a further intermediate sheet in a second laminate feed station. In the illustrated embodiment which consists of four layers only, a second intermediate laminate is not employed. The four layer laminate is then passed through a second oven which also includes a calibration roller 42, heating plates 44, calibration rollers 48,50 and cooling plates 52. The composite laminate which exits from the second oven thus consists of four layers, namely the carpet fiber web 10, reclaimed material, intermediate (fiberglass) web 20, and reclaimed material. (see FIG. 2)

By way of further example, when a second laminating process is employed, the reclaimed material may be deposited at a rate of 0.5% per minute on top of the intermediate (fiberglass) web 20. The infrared heaters 38 may be set at approximately 110° C. In the second oven, calibration roller 42 may be set at 0.5 mm. The heating plates 44 may be heated to a temperature of 200° C. with the bottom heating units at 0° C.

The finished product can then be passed to an accumulator 54 and then sized and packaged in station 56 in a conventional way.

In the preferred embodiment, the operator has the capability of determining the formula for the reclaimed material (i.e. the percentage of reclaimed material, virgin material and other additives), the lines speed, heat, pressure and thickness in order to create a final composite product such as carpeting, carpet or plastic floor tiles, liner materials, mats of all description, awnings, billboards and numerous other products. Typically, the reclaimed material comprises polyvinyl chloride, rubber, polycarbite waste or nylon fiber.

1. A method of producing a composite laminate, comprising the steps of feeding ground reclaimed material to a dispersing station, dispersing the reclaimed material on a moving web, bringing an intermediate web into engagement with the layer of reclaimed material, melting the reclaimed material to fuse the reclaimed material to the intermediate web, passing the laminate through compression rollers to control the thickness of the laminate, and cooling the laminate.

2. A method of producing a composite laminate according to claim 1, wherein said moving web comprises a carpeting type material and wherein the melted reclaimed material is fused to said carpeting type material and intermediate web.

3. A method of producing a composite laminate according to claim 2, wherein said reclaimed material is ground backing material from carpeting.

4. A method of producing a composite laminate according to claim 1, wherein said melting step comprises passing the reclaimed materials and intermediate web through an oven having heating units on opposite sides of the laminate, the heating units being independently controllable.

5. A method of producing a composite laminate according to claim 2, wherein said melting step comprises passing the reclaimed materials and intermediate web through an oven having heating units on opposite sides of the laminate, the heating units being independently controllable.
